(19) United States
(12) Patent Application Publication
(10) Pub. No.: US 2015/0307714 A1
(43) Pub. Date: Oct. 29, 2015

(54) FLY ASH REMOVING PROCESS OF SCRAP TIRE

(71) Applicant: E-SUNSCIENCE CO., LTD., Taipei City (TW)

(72) Inventor: LI-FENG CHENG, Taipei City (TW)

(21) Appl. No.: 14/694,582

(22) Filed: Apr. 23, 2015

Related U.S. Application Data
(60) Provisional application No. 61/984,405, filed on Apr. 25, 2014.

(51) Int. Cl. C09C 1/56; C09C 1/48

(52) U.S. Cl. CPC C09C 1/56; C09C 1/482

(57) ABSTRACT

A fly ash removing process of scrap tires is provided, which includes the steps of: performing a pre-treating procedure, comprising grinding a pyrolyzed carbon black and removing a granular metallic material from the pyrolyzed carbon black by a method of magnetic separation; performing a first fly ash removing procedure, comprising performing an acid-wash to the ground carbon black by an acidic solution and a chelating agent; performing a first washing procedure, comprising washing the carbon black in which the acid-wash is performed to neutralize the residual acidic solution and the chelating agent by water, and drying the washed carbon black to obtain the carbon black in which the fly ash is removed. The removing process is able to effectively reduce the contents of the fly ash contained in the pyrolyzed carbon black.

### CROSS-REFERENCE TO RELATED APPLICATION

This application claims the benefit to U.S. Provisional Patent Application No. 61/984,405, filed on Apr. 25, 2014, in the United States Patent and Trademark Office, the content of which are hereby incorporated by reference in their entirety for all purposes.

### BACKGROUND OF THE INVENTION

1. Field of the Invention

This application relates to a fly ash removing process, and more particularly, to a fly ash removing process of scrap tire which is able to remove the fly ash of scrap tires with a high removing rate.

2. Description of the Related Art

Generally, the conventional recycling methods of scrap tire are divided into two types. One is physical treating method and the other is chemical treating method. The former treating method is to separate the steel wire, nylon and rubber from the scrap tire after grinding the scrap tire, and then the rubber is recycled to be reproduced as the reclaimed rubber. The reclaimed rubber, however, is not suitable for being served as the material of tires because it belongs to the reproduction and is of lower quality. Hence, the physical treating method of recycling the scrap tires has little efficiency in the resource recovery. As to the chemical treating method of recycling the scrap tire, it adds the catalysts with an adequate concentration to pyrolyze the scrap tire at an adequate temperature and pressure after grinding the scrap tire, so as to separate the gases, mixed oils, carbon blacks, residues, and so on from the scrap tire when the scrap tire is crashed. Besides, the byproducts with high economic value such as light oil, gasoline, coal oil, heavy oil, and so on can be separated from the mixed oils by adequate methods such as fractional distillation. As a result, the scrap tires are able to be recycled effectively.

As mentioned above, the pyrolysis method is economically feasible to recycle the scrap tires. Thus, the current research and development both aim to such method. Nonetheless, the pyrolyzed carbon black still has high contents of fly ash, resulting that recycling the carbon black by the pyrolysis method is not economically feasible and cannot be applied widely.

As a result, the inventor of the present invention has been mulling it over and then designs a fly ash removing process of scrap tire to improve the current technique, and hereby boost the industrial practicability.

### SUMMARY OF THE INVENTION

In view of the foregoing technical problems, the objective of the present invention provides a fly ash removing process of scrap tire to resolve the conventional pyrolysis method concerning that the recycled carbon black has high contents of fly ash.

In accordance with the objective of the present invention, a fly ash removing process of scrap tire is provided, which may include the following steps of: performing a pre-treating procedure, comprising grinding a pyrolyzed carbon black and removing a granular metallic material from the pyrolyzed carbon black by a method of magnetic separation; performing a first fly ash removing procedure, comprising performing an acid-wash to the ground carbon black by an acidic solution and a chelating agent; performing a first washing procedure, comprising washing the carbon black in which the acid-wash is performed to neutralize the residual acidic solution and the chelating agent by water, and drying the washed carbon black to obtain the carbon black in which the fly ash is removed.

Preferably, the fly ash removing process of scrap tire may further include the following steps of: performing a second fly ash removing procedure, comprising performing an alkaline-wash to the carbon black in which the grinding or the acid-wash is performed by an alkaline solution, and performing a second washing procedure, comprising washing the carbon black in which the alkaline-wash is performed to neutralize the residual alkaline solution by water.

Preferably, the pyrolyzed carbon black may be ground into 30-320 mesh, and the method of magnetic separation may be performed under 6000-15000 Gauss.

Preferably, the acidic solution may include hydrochloric acid, nitrate, sulfuric acid, perchloric acid, formic acid, acetic acid, lactic acid, or oxalic acid, and the chelating agent may include ammonium chloride, ammonium nitrate, or ethylenediaminetertraacetic acid (EDTA).

Preferably, the acidic solution may have a concentration of 0.10 M-18.0 M, and the chelating agent may have a concentration of 0.01 M-10.0 M; a mixing ratio of the carbon black and the acidic solution may be 1/1-1/30 g/Ml, and a mixing ratio of the carbon black and the chelating agent may be 1/1-1/30 g/Ml.

Preferably, the acid-wash may be performed in the first fly ash removing procedure by a manner of stirring, a reaction temperature of stirring the carbon black and the acidic solution may be 25° C.-120° C., and a stirring time of mixing the carbon black and the acidic solution may be 10-120 minutes.

Preferably, the alkaline solution may include chloride, bromide or iodide of alkali metal (IA group).

Preferably, the alkaline solution may include sodium hydroxide, ammonia or a salt thereof.

Preferably, the alkaline solution may have a concentration of 0.10 M-10.0 M, and a mixing ratio of the carbon black and the alkaline solution may be 1/5-1/50 g/Ml.

Preferably, the alkaline wash may be performed in the second fly ash removing procedure by a manner of stirring, a reaction temperature of stirring the carbon black and the alkaline solution may be 25° C.-120° C., and a stirring time of mixing the carbon black and the alkaline solution may be 30-480 minutes.

Preferably, the first fly ash removing procedure may have a greater fly ash removing rate than the second fly ash removing procedure.

In conclusion, a fly ash removing process of scrap tire of the present invention is able to effectivity reduce the contents of the fly ash contained in the pyrolyzed carbon black, so as to promote the purity of the pyrolyzed carbon black, as well as the industrial applicability and the usage.

### BRIEF DESCRIPTION OF THE DRAWINGS

Hereinafter, embodiments of the present invention will be described in detail with reference to the accompanying drawings so that those skilled in the art to which the present invention pertains can realize the present invention, wherein:

FIG. 1 is a flow chart of the first embodiment of a fly ash removing process of scrap tire of the present invention.

FIG. 2 is a flow chart of the second embodiment of a fly ash removing process of scrap tire of the present invention.

FIG. 3 is a flow chart of the third embodiment of a fly ash removing process of scrap tire of the present invention.

### DETAILED DESCRIPTION OF THE PREFERRED EMBODIMENTS

Hereinafter, embodiments of the present invention will be described in detail with reference to the accompanying drawings so that those skilled in the art to which the present invention pertains can realize the present invention. As those skilled in the art would realize, the described embodiments may be modified in various different ways, all without departing from the spirit or scope of the present invention.

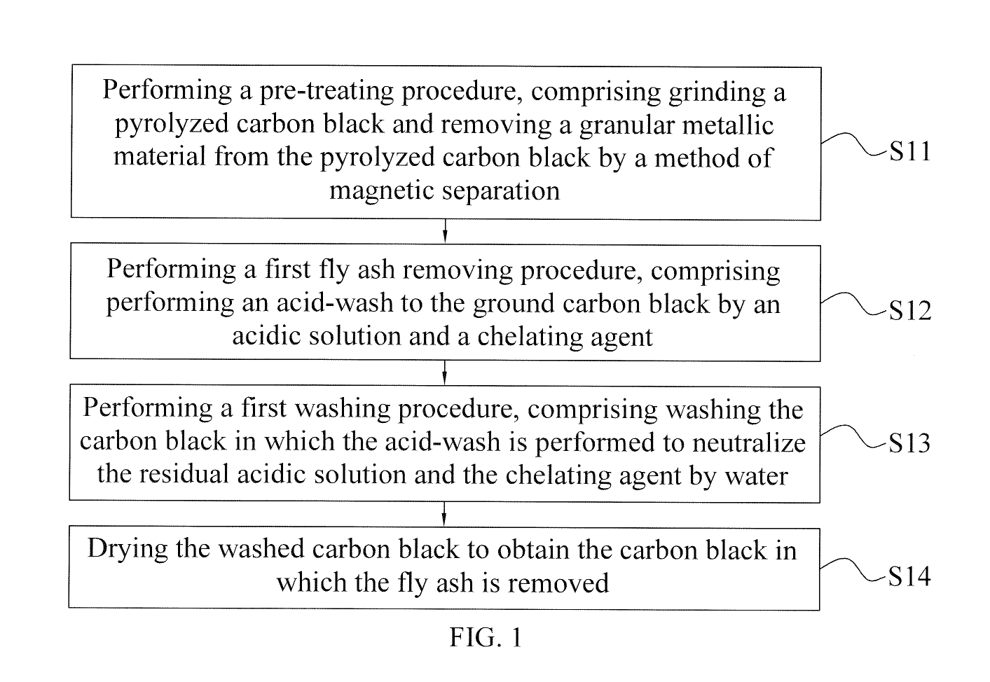

Please refer to FIG. 1 which is a flow chart of the first embodiment of a fly ash removing process of scrap tire of the present invention. As shown in the Fig., a fly ash removing process of scrap tire disclosed in the present invention mainly applies the pyrolysis method to remove the fly ash obtained from the pyrolyzed carbon black of the scrap tire through the oxidation-reduction reaction. The fly ash removing process of scrap tire includes the following steps of:
Step S11: Performing a pre-treating procedure, comprising grinding a pyrolyzed carbon black and removing a granular metallic material from the pyrolyzed carbon black by a method of magnetic separation;
Step S12: Performing a first fly ash removing procedure, comprising performing an acid-wash to the ground carbon black by an acidic solution and a chelating agent;
Step S13: Performing a first washing procedure, comprising washing the carbon black in which the acid-wash is performed to neutralize the residual acidic solution and the chelating agent by water;
Step S14: Drying the washed carbon black to obtain the carbon black in which the fly ash is removed.

The main objective of the foregoing step S11 is to grind and perform the method of magnetic separation to the carbon black pyrolyzed from the scrap tire. Briefly, the pyrolysis method is to heat the to-be-pyrolyzed object such as scrap tire to produce the hot chemical reaction in the anaerobic or oxygen deficit environment, such that the organic materials contained in the to-be-pyrolyzed object can be decomposed as gases, liquids (e.g. pyrolysis oil) and solid residues, so as to achieve the objective of the pyrolysis method. As the technique concerning the pyrolysis method applied to the scrap tires disclosed in the present invention is known towards one skilled in the art, and the unnecessary details are no longer given herein. In addition, in the step S11, the carbon black is ground to 30-320 mesh to become powdery material by grinder or grinding equipment, and then the ground carbon black is processed by the method of magnetic separation under 6000-15000 Gauss to sieve the impurities such as steel wire, cotton flock, fiber, rubber coke, sandstone, and so on out of the ground carbon black.

Regarding a first fly ash removing procedure of the foregoing step (S12), it performs an acid-wash to the ground carbon black by an acidic solution. The acidic solution may be the commonly-used inorganic or organic acidic solutions. The inorganic acidic solutions may include hydrochloric acid, nitrate, sulfuric acid, perchloric acid, and the inorganic acidic solutions may be formic acid, acetic acid, lactic acid, or oxalic acid. In addition, the chelating agent may be selected from one of ammonium chloride, ammonium nitrate, and ethylenediaminetertraacetic acid (EDTA), or a combination thereof. In the first fly ash removing procedure, the mixture of the aforementioned acidic solution and the chelating agent is applied to perform the acid-wash to the ground carbon black and the carbon black in which the acid-wash is performed. To be precise, the acidic solution has a concentration of 0.10 M-18.0 M, and the chelating agent has a concentration of 0.01 M-10.0 M. Next, the ground carbon black and the carbon black in which the acid-wash is performed are mixed with the acidic solution by a mixing ratio of 1/1-1/30 g/Ml, and the carbon black and the chelating agent are mixed by a mixing ratio of 1/1-1/30 g/Ml and are stirred under a predetermined condition. Preferably, a reaction temperature of stirring the carbon black and the acidic solution is 25° C.-120° C., and a stirring time of mixing the carbon black and the acidic solution is 10-120 minutes.

The mixing ratio of the carbon black, acidic solution and chelating agent are taken for example. The acidic solution and the chelating agent are applied by a concentration of 2 M and 1 M, respectively, and the carbon black and the acidic solution both have the same mixing ratio of 1/30 g/Ml. So, when 10 g carbon black is applied, the acidic solution having a concentration 2 M is applied by 300 ml and the additive amount of the chelating agent which is added to the acidic solution having a concentration 2 M with 300 ml can be calculated by the concentration. If the ammonium chloride is applied as the chelating agent and the molecular weight thereof is 53.49, the additive amount can be calculated according to the following formula.

10 g (carbon black)*1 m (concentration)*30 (mixing ratio)*53.49 (molecular weight)/1000=16.047 g (chelating agent).

Therefore, adding 16.047 g of the chelating agent (ammonium chloride) to the acidic solution having 2 M concentration with 300 ml will produce the acidic solution having a concentration of 2 M with 300 ml and the chelating agent having a centration of 1 M. Afterwards, 10 g carbon black is mixed with the foregoing mixed solution with 300 ml.

After being performed the pre-treating procedure and the first fly ash removing procedure, the contents of the fly ash contained in the pyrolyzed carbon black can be effectively and greatly reduced. When the contents of the fly ash contained in the pyrolyzed carbon black are reduced effectively and greatly, performing the steps S13 and S14 in order can thereby obtain the carbon black of high purity. There are no the specific processing conditions needed to dry the carbon black in the washing procedures of S13 and S14. Preferably, the manner of drying the carbon black can be a manner of stationary drying, and the unnecessary details are no longer given herein.

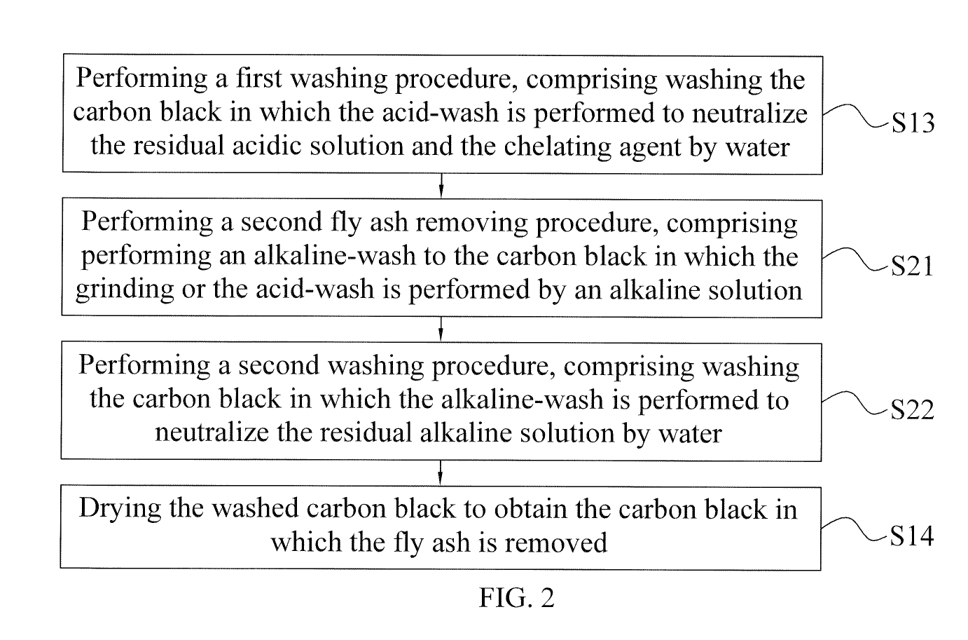

Please refer to FIG. 2 which is a flow chart of the second embodiment of a fly ash removing process of scrap tire of the present invention. A fly ash removing process of scrap tire disclosed in the present invention may also include a second fly ash removing procedure. The second fly ash removing procedure mainly includes performing an alkaline-wash to the carbon black in which the grinding or the acid-wash is performed by an alkaline solution, and the second fly ash removing procedure may be performed between the pre-treating procedure and the first fly ash removing procedure. Additionally, the second fly ash removing procedure may also be performed after the step S13 is completed. Preferably, the second fly ash removing procedure may have a better efficiency provided that it is performed after the step S13 is completed. Here, the present embodiment applies the second fly ash removing procedure which is performed after the step S13 is completed as the exemplary embodiment, but it shall be not limited thereto.

The second fly ash removing procedure includes the following steps of:
Step S21: Performing the second fly ash removing procedure, comprising performing an alkaline-wash to the carbon black in which the grinding or the acid-wash is performed by an alkaline solution; and
Step S22: Performing a second washing procedure, comprising washing the carbon black in which the alkaline-wash is performed to neutralize the residual alkaline solution by water.

To be precise, the alkaline solution includes chloride, bromide or iodide of alkali metal (IA group) such as sodium hydroxide, ammonia or a salt thereof. The alkaline solution has a concentration of 0.10 M-10.0 M, and a mixing ratio of the ground carbon black or the carbon black in which the acidic-wash is performed and the alkaline solution is 1/5-1/50 g/Ml. Afterwards, a reaction temperature of stirring the carbon black and the alkaline solution is 25° C.-120° C., and a stirring time of mixing the carbon black and the alkaline solution is 30-480 minutes.

It is noteworthy that after being ground and performed the method of magnetic separation, the metal contents of the pyrolyzed carbon black are reduced from 12-15% (weight percentage) to 0.1-2%. After being ground and performed the method of magnetic separation, the metal contents of the pyrolyzed carbon black in which the acid-wash is performed are reduced from 18-22% to 7-10%. After being performed the alkaline-wash, the metal contents of the pyrolyzed carbon black are reduced from 7-10%45-2%. That is to say, the metal contents of the pyrolyzed carbon black can be reduced greatly after being ground and performed the method of magnetic separation, and the first fly ash removing procedure (acid-wash) has a greater fly ash removing rate than the second fly ash removing procedure (alkaline-wash). In addition, the remaining fly ash and the residual metal contents contained in the carbon black can be further removed after being performed the first fly ash removing procedure and the second fly ash removing procedure.

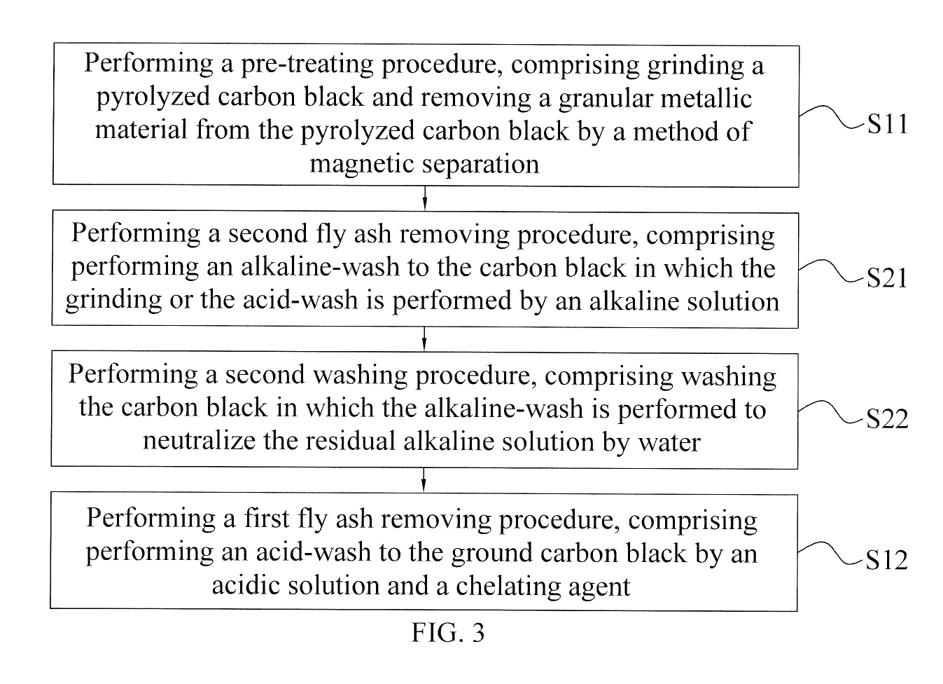

Please refer to FIG. 3 which is a flow chart of the third embodiment of a fly ash removing process of scrap tire of the present invention. In the present embodiment, the second fly ash removing procedure performed between the pre-treating procedure and the first fly ash removing procedure is applied as an exemplary aspect, and the specific processing conditions are identical to that used in the first and the second embodiments. Hence, the unnecessary details are no longer given herein.

In conclusion, after being ground and performed the method of magnetic separation, acid-wash, and alkaline-wash applied in the fly ash removing process of scrap tire disclosed in the present invention, the contents of the fly ash contained in the pyrolyzed carbon black are effectivity reduced from 18-22% to 0.5-2% (weight percentage), and the carbon black with high purity is hereby obtained. As a result, a fly ash removing process of scrap tire of the present invention is not only able to produce the carbon black with high purity, but also economically feasible to the market.

While the means of specific embodiments in present invention has been described by reference drawings, numerous modifications and variations could be made thereto by those skilled in the art without departing from the scope and spirit of the invention set forth in the claims. The modifications and variations should in a range limited by the specification of the present invention.

1. A fly ash removing process of scrap tire, comprising steps of:
performing a pre-treating procedure, comprising grinding a pyrolyzed carbon black and removing a granular metallic material from the pyrolyzed carbon black by a method of magnetic separation;
performing a first fly ash removing procedure, comprising performing an acid-wash to the ground carbon black by an acidic solution and a chelating agent;
performing a first washing procedure, comprising washing the carbon black in which the acid-wash is performed to neutralize the residual acidic solution and the chelating agent by water, and
drying the washed carbon black to obtain the carbon black in which the fly ash is removed.

2. The fly ash removing process of scrap tire of claim 1, further comprising steps of:
performing a second fly ash removing procedure, comprising performing an alkaline-wash to the carbon black in which the grinding or the acid-wash is performed by an alkaline solution, and
performing a second washing procedure, comprising washing the carbon black in which the alkaline-wash is performed to neutralize the residual alkaline solution by water.

3. The fly ash removing process of scrap tire of claim 2, wherein the pyrolyzed carbon black is ground into 30-320 mesh, and the method of magnetic separation is performed under 6000-15000 Gauss.

4. The fly ash removing process of scrap tire of claim 2, wherein the acidic solution comprises hydrochloric acid, nitrate, sulfuric acid, perchloric acid, formic acid, acetic acid, lactic acid, or oxalic acid, and the chelating agent comprises ammonium chloride, ammonium nitrate, or ethylenediaminetertraacetic acid (EDTA).

5. The fly ash removing process of scrap tire of claim 4, wherein the acidic solution has a concentration of 0.10 M-18.0 M, and the chelating agent has a concentration of 0.01 M-10.0 M; a mixing ratio of the carbon black and the acidic solution is 1/1-1/30 g/Ml, and a mixing ratio of the carbon black and the chelating agent is 1/1-1/30 g/Ml.

6. The fly ash removing process of scrap tire of claim 5, wherein the acid-wash is performed in the first fly ash removing procedure by a manner of stirring, a reaction temperature of stirring the carbon black and the acidic solution is 25° C.-120° C., and a stirring time of mixing the carbon black and the acidic solution is 10-120 minutes.

7. The fly ash removing process of scrap tire of claim 2, wherein the alkaline solution comprises a chloride, bromide or iodide of alkali metal (IA group).

8. The fly ash removing process of scrap tire of claim 7, wherein the alkaline solution comprises sodium hydroxide, ammonia or a salt thereof.

9. The fly ash removing process of scrap tire of claim 8, wherein the alkaline solution has a concentration of 0.10 M-10.0 M, and a mixing ratio of the carbon black and the alkaline solution is 1/5-1/50 g/Ml.

10. The fly ash removing process of scrap tire of claim 9, wherein the alkaline wash is performed in the second fly ash removing procedure by a manner of stirring, a reaction temperature of stirring the carbon black and the alkaline solution is 25° C.-120° C., and a stirring time of mixing the carbon black and the alkaline solution is 30-480 minutes.

11. The fly ash removing process of scrap tire of claim 2, wherein the first fly ash removing procedure has a greater fly ash removing rate than that of the second fly ash removing procedure.
